(19) United States
(12) Patent Application Publication
(10) Pub. No.: US 2020/0189151 A1
(43) Pub. Date: Jun. 18, 2020

(54) APPARATUS AND METHOD FOR REMOVING FLASHING FROM AN ARTICLE

(71) Applicant: Steere Enterprises Inc., Tallmadge, OH (US)

(72) Inventors: Jacob Conrad, Wooster, OH (US); Dean Carson, Louisville, OH (US)

(73) Assignee: Steere Enterprises Inc., Tallmadge, OH (US)

(21) Appl. No.: 16/711,625

(22) Filed: Dec. 12, 2019

Related U.S. Application Data
(60) Provisional application No. 62/778,541, filed on Dec. 12, 2018.

(51) Int. Cl. B29C 37/02

(52) U.S. Cl. CPC B29C 37/02

(57) ABSTRACT

In one embodiment, this disclosure describes a method for removing flashing from an article. The method includes the steps of configuring a deflashing apparatus in a loading condition; loading the article into a nesting portion of a first nesting plate of the deflashing apparatus; engaging an actuating mechanism to actuate a drive assembly of the deflashing apparatus; continuing to engage the actuating mechanism to facilitate movement of a press plate of the deflashing apparatus toward the first nesting plate; releasing the actuating mechanism to retract the press plate, and returning the press plate to the loading condition. During this method, the press plate compresses against the first nesting plate such that flashing of the article is separated from the article. The deflashing apparatus can include interchangeable nesting plate to fit various articles.

### CROSS-REFERENCE TO RELATED APPLICATIONS

This application claims priority to pending U.S. Provisional Patent Application Ser. No. 62/778,541, titled “Apparatus and Method for removing Flashing from an Article,” filed on Dec. 12, 2018, which is expressly incorporated by reference herein in its entirety.

### TECHNICAL FIELD

This disclosure generally relates to an apparatus and a method for removing flashing from an article. More specifically, this disclosure relates to an apparatus and a method for removing flashing from an article formed during a manufacturing process.

### BACKGROUND

Flashing, also known as flash, is a by-product of manufacturing processes that results in excessive material attached to a cast, forged, molded or welded parts and components (generally referred to as “articles” herein). Flashing can appear on an edge of the article, along a parting line of a mold, or anywhere that the mold has an interface that forms a boundary of the manufactured article. Flashing is typically removed from the article for a variety of reasons including aesthetic, practical, and functional reasons. The process of removing flashing is often referred to as “deflashing.” For example, flashing is removed when it is present in an area where surface finish is important, where flashing can cause a safety risk such as cutting a user of the article, or where flashing will cause an interference fit with mating articles. A common method of flashing removal is for a manufacturing worker to manually use a knife or other cutting instrument to trim the flashing or use a mallet to forcibly remove the flashing. However, as will be appreciated, such methods are time consuming, difficult to consistently repeat, and inefficient in many manufacturing environments.

An automated deflashing press can be used to remove the flashing on the cast, forged, molded or welded article. When deflashing a particular article, a deflashing press requires tooling unique to the article. For example, to successfully remove flashing from the article, a nesting plate and a press plate must be specifically formed to the article so as to not damage the article while deflashing. Consequently, different deflashing presses are needed to deflash different articles, which can be cost prohibitive, consume excessive space, and require burdensome training.

### BRIEF DESCRIPTION OF THE DRAWINGS

In the accompanying drawings, structures are illustrated that, together with the detailed description provided below, describe examples of the disclosed apparatuses and methods. Where appropriate, like features are identified with the same or similar reference numerals. Features shown as a single component can be replaced with multiple components. Features shown as multiple components can be replaced with a single component. The drawings may not be to scale. The proportion of certain features may be exaggerated for the purpose of illustration.

FIG. 1 depicts an example of a front-left perspective view of an apparatus for removing flash.

FIG. 2 depicts an example of rear-right perspective view of an apparatus for removing flash.

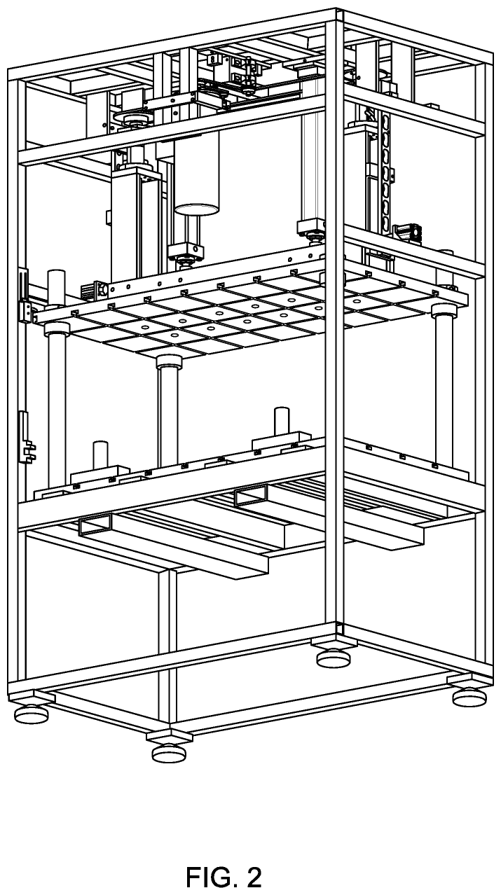

FIG. 3 depicts an example of a partial rear perspective view of an apparatus for removing flash.

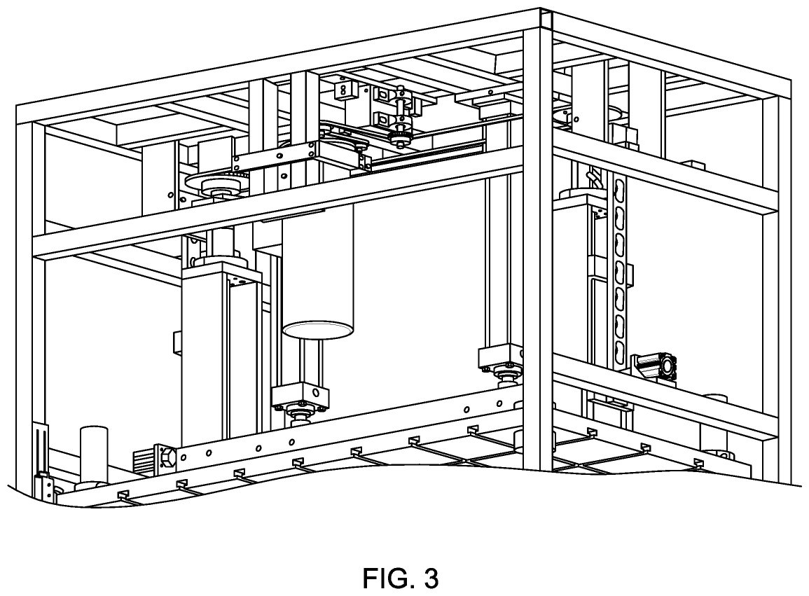

FIG. 4 depicts a partial side view of an apparatus for removing flash.

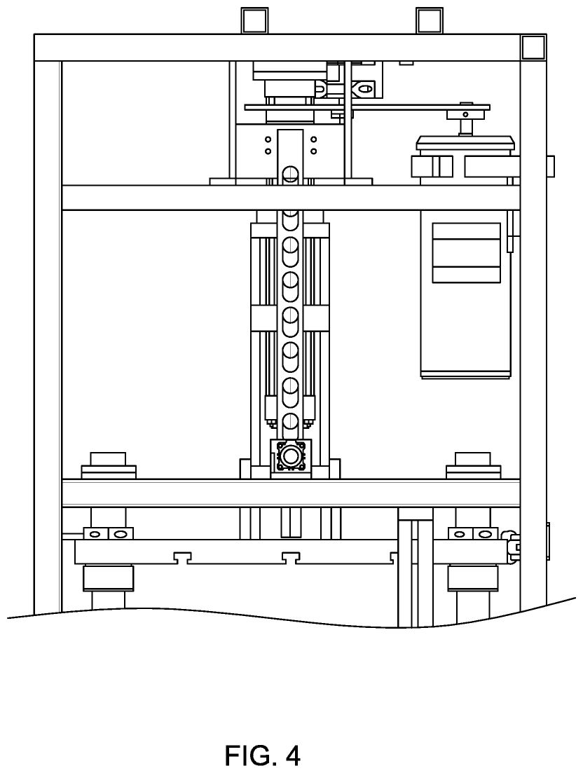

### SUMMARY

In one embodiment, this disclosure describes a method for removing flashing from an article. The method includes the steps of configuring a deflashing apparatus in a loading condition; loading the article into a nesting portion of a first nesting plate of the deflashing apparatus; engaging an actuating mechanism to actuate a drive assembly of the deflashing apparatus; continuing to engage the actuating mechanism to facilitate movement of a press plate of the deflashing apparatus toward the first nesting plate; releasing the actuating mechanism to retract the press plate, and returning the press plate to the loading condition. During this method, the press plate compresses against the first nesting plate such that the flashing of the article is separated from the article. The deflashing apparatus can include interchangeable nesting plate to fit various articles.

This Summary is provided merely for purposes of summarizing some examples to provide a basic understanding of some aspects of the disclosure. Accordingly, it will be appreciated that the above described examples are merely examples and should not be construed to narrow the scope or spirit of the disclosure in any way. Other examples, aspects, and advantages of various disclosed examples will become apparent from the following detailed description taken in conjunction with the accompanying drawings which illustrate, by way of example, the principles of the described examples.

### DETAILED DESCRIPTION

The apparatus and method disclosed in this document are described in detail by way of examples and with reference to the figures. It will be appreciated that modifications to disclosed and described examples, arrangements, configurations, components, features, apparatuses, methods, materials, etc. can be made and may be desired for a specific application. In this disclosure, any identification of specific techniques, arrangements, methods, etc. are either related to a specific example presented or are merely a general description of such a technique, arrangement, method, etc. Identifications of specific details or examples are not intended to be and, should not be, construed as mandatory or limiting unless specifically designated as such. Selected examples of a deflashing apparatus and a method of using such an apparatus are hereinafter disclosed and described in detail.

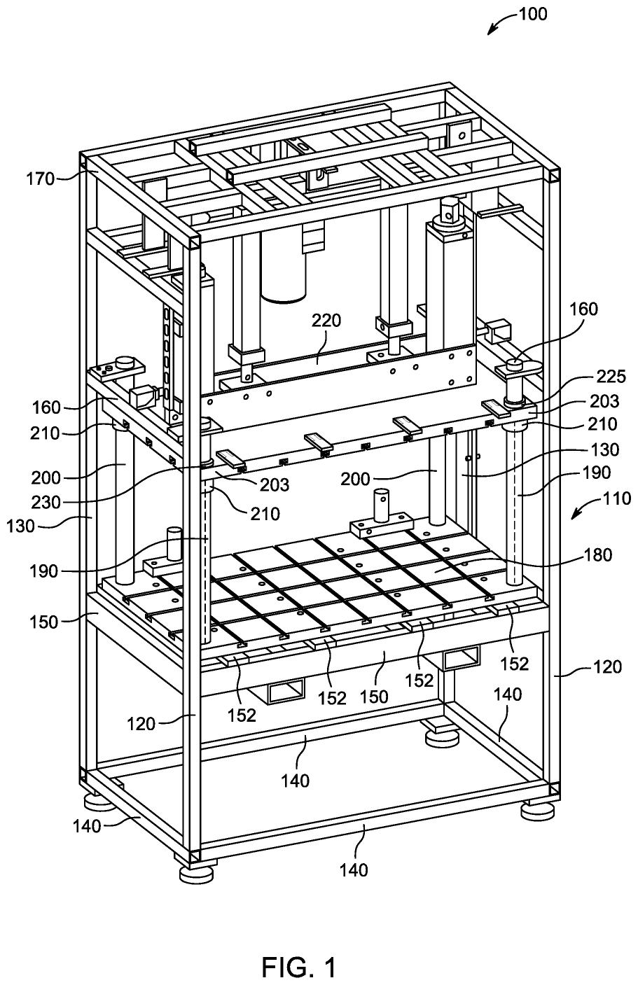

FIG. 1 depicts an example of a deflashing apparatus 100. The deflashing apparatus 100 can be used to remove flashing from an assortment of articles fabricated from a variety of materials including, but not limited to, plastics, rubbers, metals, and alloys.

The deflashing apparatus 100 can be arranged to be semi-automated, where articles are positioned in the deflashing apparatus 100 manually by an operator, and the operator initiates the deflashing process by engaging a mechanism, such as a palm button, or some other manual initiation mechanism. Alternatively, the deflashing apparatus 100 can be arranged to be fully automatic, where articles are automatically placed in the deflashing apparatus 100 by a conveyor, robotic arm, or other automated process, and the deflashing process is initiated by sensors that determine when the article is correctly positioned in the deflashing apparatus 100.

The deflashing apparatus 100 can include a frame assembly 110 comprised of a series of fixed beams coupled to one another to form the structure of the deflashing apparatus 100. The frame assembly 110 can provide structure and support to the deflashing apparatus 100 and can provide a generally rectangular scaffold from which integral features of the deflashing apparatus 100 can be coupled.

The frame assembly 110 can include a pair of vertical anterior beams 120 that are substantially parallel and laterally oppose one another. The frame assembly 110 can also include a pair of vertical posterior beams 130 that are substantially parallel and laterally oppose one another. The vertical anterior beams 120 and vertical posterior beams 130 are positioned so as to form four corners of the three-dimensional rectangular scaffold of the frame assembly 110.

In addition, the frame assembly 110 can include four horizontal base beams 140 at a lower-most location of the anterior beams 120 and the posterior beams 130. As illustrated in FIG. 1, each of the four horizontal base beams 140 interconnects either a vertical anterior beam 120 to another vertical anterior beam 120, a vertical posterior beam 130 to another vertical posterior beam 130, or a vertical anterior beam 120 to a vertical posterior beam 130 on a corresponding side of the frame assembly 110. The deflashing apparatus 100 can include additional horizontal base beams or diagonally arranged beams as needed for increased support.

The frame assembly 110 can further include four horizontal support beams 150 located above the horizontal base beams 140. The horizontal support beams 150 can be positioned similarly to the horizontal base beams 140 as illustrate in the figures. Horizontal slats 152 can be coupled to the horizontal support beams 150 to create a slatted platform 154, which can create a working base of the deflashing apparatus 100.

Above the support beams 150, the frame assembly 110 can include two horizontal middle beams 160. The horizontal middle beams 160 can laterally oppose one another and connect a vertical anterior beam 120 to a vertical posterior beam 130 on a corresponding side of the frame assembly 110. The structure of the horizontal middle beams 160 can support a number of necessary components of the deflashing apparatus 100. In addition, the deflashing apparatus 100 can include additional horizontal middle beams 160 for increased support and scaffolding for coupling features.

Above the middle beams 160, the frame assembly 110 can further include four horizontal top beams 170. The top beams 170 can be positioned to engage with the top end of the vertical anterior beams 120 and vertical posterior beams 130. The horizontal top beams 170 can be arranged similarly to the horizontal base beams 140, where each of the four horizontal top beams 170 interconnects either a vertical anterior beam 120 to another vertical anterior beam 120, a vertical posterior beam 130 to another vertical posterior beam 130, or a vertical anterior beam 120 to a vertical posterior beam 130 on a corresponding side of the frame assembly 110. The deflashing apparatus 100 can include additional top beams or diagonally arranged beams as needed for increased support for the deflashing apparatus 100.

The deflashing apparatus 100 can further include a nesting plate 180 having a bottom surface and a top surface. The bottom surface of the nesting plate 180 can face the slatted platform 154, and the top surface of the nesting plate 180 can face the horizontal middle beams 160 and the horizontal top beams 170. The nesting plate 180 can be coupled to the slatted platform 154 so as to fixedly secure it to the deflashing apparatus 100.

The top surface of the nesting plate 180 can be fabricated so as to include a nesting portion encompassed by a deflashing portion. The nesting portion can provide a cradle within which the article to be deflashed can easily and securely rest. The nesting portion can be formed such that its contours interface with the surface contours of the article that is to be deflashed. In such an arrangement, any flashing present on the article can rest outside the nesting portion and on the top surface of the deflashing portion. As will be appreciated, in such an arrangement, the article to be deflashed can rest securely within the nesting portion prior to, during, and after the deflashing process, and the flashing of the article can be easily and efficiently removed from the article.

The deflashing apparatus 100 can include a plurality of customized nesting plates 180 fabricated to fit a plurality of unique articles. The plurality of nesting plates 180 can be fabricated so that they can be easily interchanged on the deflashing apparatus 100. Namely, the slatted platform 154 and each of the plurality of nesting plates 180 are configured to securely couple and efficiently release from one another. This interchangeability can allow a single deflashing apparatus 100 to deflash a number of different articles. Such an arrangement can negate the need for multiple deflashing apparatuses.

The deflashing apparatus 100 can further include a pair of vertical anterior rods 190 and a pair of vertical posterior rods 200. The vertical anterior rods 190 and vertical posterior rods 200 can extend between the slatted platform 154 and the middle beams 160. A base of each vertical anterior rods 190 and vertical posterior rods 200 can be coupled to one or more of the slatted platform 154 and the nesting plate 180. The nesting plate 180 can include four openings 202 commensurate with the position of each vertical anterior rod 190 and vertical posterior rod 200. The openings 202 can extend from the top surface to the bottom surface of the nesting plate 180 to enable the vertical anterior rods 190 and vertical posterior rods 200 to extend therethrough. A top end of each vertical anterior rods 190 and vertical posterior rods 200 can be coupled to the middle beams 160.

The vertical anterior rods 190 can laterally oppose one another and can be arranged substantially commensurate with the vertical anterior beams 120. The vertical posterior rods 200 can laterally oppose one another and can be arranged substantially commensurate with the vertical posterior beams 130. A vertical translational axis 203 can extend along a length of each vertical anterior rod 190 and each vertical posterior rod 200.

A ring 210 can be translationally disposed on each vertical anterior rod 190 and vertical posterior rod 200 in a manner that allows the ring 210 to translate vertically along corresponding vertical anterior rod 190 and vertical posterior rod 200. In some examples, each ring 210 can be arranged to translate vertically along the entire length of its corresponding rod 190 and 200. In other examples, each ring 210 can be arranged to translate vertically along a portion of the length of its corresponding vertical anterior rod 190 or vertical posterior rod 200. Such arrangements can be designed to accommodate a thickness of the nesting plate 180 and a height of an article to be deflashed. As will be subsequently discussed, the rings 210 can be arranged to support other components of the deflashing apparatus 100.

In addition, the deflashing apparatus 100 can include a press plate 220 arranged above the nesting plate 180. The press plate 220 can include a bottom surface and a top surface. The bottom surface of the press plate 220 can face the top surface of the nesting plate 180. The top surface of the press plate 220 can face the horizontal middle beams 160 and the horizontal top beams 170.

The bottom surface of the press plate 220 can be fabricated so as to include a nesting portion encompassed by a deflashing portion, which are a mirror image of the nesting portion and the deflashing portion of the nesting plate 180, respectively. However, that is not to say that contours of the nesting portion of the press plate 220 cannot differ from the contours of the nesting portion of the nesting plate 180. The contours of the nesting portions may differ to account for differences in features between the portions of an article to be deflashed, desired fit of an article to be deflashed, or for any other reason.

The nesting portion and the deflashing portion of the press plate 220 can directly oppose the nesting portion and the deflashing portion of the nesting plate 180, respectively. As such, upon engagement of the press plate 220 with the nesting plate 180, the respective nesting portions and the deflashing portions engage one another.

Upon engagement of the press plate 220 with the nesting plate 180, the two plates 180 and 220 can envelope the article to be deflashed, such that it is secured between them. In this arrangement, the nesting portion of the press plate 220 can cover the article to be deflashed, and the deflashing portion of the press plate 220 can engage any flashing present on the article to be deflashed. As will be appreciated, in such an arrangement, the article to be deflashed is secured within the nesting portion prior to, during, and after the deflashing process.

Similar to the nesting plate 180, the press plate 220 can be customized for a specific article. The surface contours of the nesting portion of the press plate 220 can be formed to the specifications of a particular article. Namely, the plurality of press plates 220 are configured to securely couple and efficiently release from the assembly frame 110. This interchangeability can allow a single deflashing apparatus 100 to deflash a number of different articles. Such an arrangement can negate the need for multiple deflashing apparatuses

The press plate 220 can include four openings 225 that can extend through the press plate 220 from the bottom surface to the top surface. A location of each opening 225 can correspond to a position of each vertical anterior rod 190 and vertical posterior rod 200 as it is coupled to one or more of the slatted platform 154 and the nesting plate 180. In this arrangement, each vertical anterior rod 190 and vertical posterior rod 200 can easily extend through a corresponding opening 225 without disruption. Accordingly, the press plate 220 can slidingly engage the vertical anterior rod 190 and vertical posterior rod 200, such that the press plate 220 can smoothly translate vertically along the translational axis 203 of the vertical anterior rods 190 and vertical posterior rods 200.

In addition, the press plate 220 can be arranged above the rings 210 on each vertical anterior rod 190 and vertical posterior rod 200. In this arrangement, the bottom surface of the press plate 220 can rest on a top surface of each ring 210 such that the rings 210 in part secure the press plate 220 to the vertical anterior rods 190 and vertical posterior rods 200.

A stationary ring 230 can be fixedly coupled to each vertical anterior rod 190 and vertical posterior rod 200 at a position above the press plate 220. This stationary ring 230 can act as a stop for the press plate 220, limiting translation of the press plate 220 above the stationary ring 230 along each vertical anterior rod 190 and vertical posterior rod 200. In some examples, when the top surface of the press plate 220 translates along the translational axis 203 to a position where it abuts a bottom surface of the stationary ring 230, the stationary ring 230 can restrict further movement of the press plate 220.

The deflashing apparatus 100 can further include a drive assembly 240 that can facilitate translation of the press plate 220 vertically along the translational axes 203 of the vertical anterior rods 190 and vertical posterior rods 200. In one example, the drive assembly 240 can be driven by hydraulic power. In another example, the deflashing apparatus 100 can be driven by pneumatic power. In a further example, the deflashing apparatus 100 can be driven by electrical power. In essence, any practical power source, or combination of power sources, can be used provided it can generate sufficient power to remove flashing from the article.

In the example of FIG. 1, the deflashing apparatus can include an electric motor (not shown), a sprocket for the electric motor, two idler sprockets, two idler sprocket shafts, four idler sprocket bearings, two ball screws and/or ball screw nuts, a roller chain, and a guide for the roller chain. A programmable logic controller can control the electric motor. Further, to ensure safe operation, an electric brake can be included on the electric motor, and a motor safety stop can be located at an operator control center (not shown) at the anterior of the deflashing apparatus 100. In this arrangement, an output shaft from the electric motor can be keyed to a roller chain sprocket. The electric motor can drive sprockets coupled to the two ball screws, where one ball screw is located on either side of the deflashing apparatus 100. A ball screw nut of each ball screw can be coupled to the press plate 220 to facilitate movement.

The drive assembly 240, illustrated in FIG. 1, can further include pneumatic cylinders (not shown) coupled to one or more of the frame 110 and the press plate 220 to assist the electric drive and to act as a safety stop in the event of a catastrophic roller chain failure. Using air, the pneumatic cylinders can extend while the press plate 220 is being driven downward, and, using a spring force, can retract when the press plate 220 is being driven upward. In one example, if the deflashing apparatus 100 loses electric power and/or air during operation, the pneumatic cylinders can extend and prevent further translation of the press plate 220. Or, in another example, the safety stop can be used to engage the pneumatic cylinders to prevent further translation of the press plate 220. An air dump (not shown) can be coupled to the deflashing apparatus 100, which can activate when the safety stop is activated. Upon activation of the air dump, the pneumatic cylinders can be de-energized.

Tooling used in the deflashing apparatus 100, including but not limited to, the nesting plate 180 and the press plate 220, can be constructed of materials such as metals, alloys, and polymers to provide robust, durable tooling. In some examples, the tooling can be fabricated of aluminum. In other examples, the tooling can be constructed of steel. In still further examples, the tooling can be fabricated of polyurethane. It is preferable that polyurethane is utilized when it is critical that an article to be deflashed is not to be scuffed and/or scratched. The tooling can be fabricated by conventional manufacturing processes, including but not limited to, computer numerical control machining and three-dimensional printing.

The deflashing apparatus 100 can be ergonomic to provide an operator with an efficient and comfortable working environment. In addition, the deflashing apparatus 100 can include safety features to limit the occurrence of adverse events, such as operator-related injuries. In one example, the deflashing apparatus 100 can include a pair of safety straps coupled to either side of the deflashing apparatus 100 that function as an emergency stop mechanism. Specifically, each safety strap can be coupled to a rod of the pneumatic cylinders, and they can be constructed so that they prevent downward translation of the press plate 220 while the cylinder rods are extended. The safety straps can help avert or reduce existing hazards to an operator and damage to tooling and/or the article undergoing the deflashing in progress.

In another example, the deflashing apparatus 100 can include guards (not shown) to prevent injury to an operator. The guards can be placed around a portion of a perimeter of the deflashing apparatus 100, leaving an opening along the operator control center at the front of the deflashing apparatus 100. Another guard can be placed along the front edge of the press plate 220 to protect an operator while the press plate 220 is compressing the nesting plate 180 during deflashing of an article.

In an additional example, the deflashing press can include palm buttons located at the operator control center. An operator must engage the palm buttons to operate the deflashing apparatus 100. This prevents unintentional operation, which in turn, increases the safety of the deflashing apparatus 100.

In further examples, the deflashing apparatus 100 can include one or more sensors (not shown), including but not limited to a motion sensor and an infrared sensor, to provide another emergency stop mechanism. The one or more sensors can detect whether an operator's hands are removed abruptly, in a reactionary fashion, from the deflashing apparatus 100, and subsequently, stop operation of the deflashing apparatus 100.

FIG. 1 depicts the deflashing apparatus in a loading condition. In some examples, when in the loading condition, the press plate 220 is positioned along the vertical anterior rods 190 and vertical posterior rods 200, such that the top surface of the press plate 220 abuts the bottom surface of each stationary ring 230. In other examples, in the loading condition, the press plate 220 is positioned along the vertical anterior rods 190 and vertical posterior rods 200, such that it is conducive to loading an article into the nesting plate 180. A stop mechanism can be used to maintain each loading position.

Once an article to be deflashed is loaded into the deflashing apparatus 100 the press plate 220 can be translated downward toward nesting plate 180 to remove flashing from the article. This is to say that after the article to be deflashed has been loaded into the nesting portion of the nesting plate 180, the press plate 220 can be translated downward along the translational axes 203 of the vertical anterior rods 190 and vertical posterior rods 200 to a position along each vertical anterior rods 190 and vertical posterior rods 200 where the press plate 220 engages with the nesting plate 180. In this position, the nesting plate 180 and the press plate 220 can be compressed together, where the nesting portion and the deflashing portion of each plate 180 and 220 are correspondingly pressed together. Upon compression, each deflashing portion of the plates 180 and 220 exerts optimal shear force on the flashing to remove the flashing from the article through that shearing force.

Furthermore, the deflashing apparatus 100 can be arranged in an unloading condition. In some examples, in the unloading condition, the press plate 220 is positioned along the vertical anterior rods 190 and vertical posterior rods 200, such that the top surface of the press plate 220 abuts the bottom surface of each stationary ring 230. In other examples, in the loading condition, the press plate 220 is positioned along the vertical anterior rods 190 and vertical posterior rods 200, such that it is conducive to unloading a deflashed article from the nesting plate 180. As will be understood, in such a position, the deflashed article can be removed from the deflashing apparatus 100.

In view of the foregoing structural and functional features described above, methods can be implemented using the deflashing apparatus 100 to deflash articles. While, for purposes of simplicity of description, method is described as executing serially, it is to be understood and appreciated that such method is not limited by the illustrated order, as some aspects could, in other examples, occur in different orders and/or concurrently with other aspects from that shown and described herein. Moreover, not all features described may be required to implement a method.

A method for removing flashing from an article can include providing an article including flashing, which has been formed by molding or other manufacturing processes. The method can further include arranging a deflashing press 100 into a loading condition. Subsequently, the method can include loading the article into a nesting portion of a nesting plate 180 of a deflashing apparatus 100. The article is appropriately loaded when it rests securely within the nesting portion and the flashing is resting on a top surface of a deflashing portion of the deflashing apparatus 100. The method can further include engaging an actuating mechanism, such as a palm button, to actuate a drive assembly of the deflashing press 100. Additionally, the method can include continuing to engage the actuating mechanism, so as to continue operating the drive assembly, thereby facilitating downward translation of the press plate 220 toward the nesting plate 180. The method can then include compressing the press plate 220 against the nesting plate 180, such that the deflashing portions of each plate 180 and 220 engage each other, and consequently, any flashing of the article. Further, the method can include continuing to engage the actuating mechanism to continue to compress the press plate 220 against the nesting plate 180 until the flashing separates from the article. The method can also include releasing the actuating mechanism to retract the press plate 220 upward such that it returns to the loading condition. Moreover, the method can include removing the article from the deflashing apparatus 100, and subsequently, removing the flashing from the deflashing apparatus 100.

The foregoing method can be practiced using any of the plurality of customized nesting plates 180 and press plates 220.

What have been described above are examples. It is, of course, not possible to describe every conceivable combination of features or methods, but one of ordinary skill in the art will recognize that many further combinations and permutations are possible. Accordingly, the disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such feature, neither requiring nor excluding two or more such features. As used herein, the term “includes” means includes but not limited to, and the term “including” means including but not limited to. The term “based on” means based at least in part on.

We claim:

1. A method for removing flashing from a first article, the method comprising:
configuring a deflashing apparatus into a loading condition;
loading the first article into a nesting portion of a first nesting plate of the deflashing apparatus;
engaging an actuating mechanism to actuate a drive assembly of the deflashing apparatus;
continuing to engage the actuating mechanism to continue operating the drive assembly to facilitate movement of a first press plate of the deflashing apparatus downwardly toward the first nesting plate,
wherein the first press plate compresses against the first nesting plate such that deflashing portions of the first nesting plate and the first press plate engage one another and the flashing of the first article, and
continuing to engage the actuating mechanism until the flashing is separated from the first article;
releasing the actuating mechanism to retract the press plate upwardly, returning the first press plate to the loading condition;
removing the first article from the deflashing apparatus; and
removing the flashing from the deflashing apparatus.

2. The method of claim 1, further comprising interchanging the first nesting plate with a second nesting plate fabricated to fit a second article.

3. The method of claim 2, further comprising interchanging the first press plate with a second press plate fabricated to fit the second article.

4. The method of claim 3, further comprising repeating the steps of claim 1 to remove flashing from the second article.
